(19) United States
(12) Patent Application Publication
(10) Pub. No.: US 2013/0185228 A1
(43) Pub. Date: Jul. 18, 2013

(54) System and Method of Data Collection, Analysis and Distribution

(71) Applicant: Steven Dresner, Muttontown, NY (US)

(72) Inventor: Steven Dresner, Muttontown, NY (US)

(21) Appl. No.: 13/743,028

(22) Filed: Jan. 16, 2013

Related U.S. Application Data
(60) Provisional application No. 61/587,888, filed on Jan. 18, 2012.

(51) Int. Cl. G06Q 40/06

(52) U.S. Cl. CPC G06Q 40/06
USPC 705/36 R

(57) ABSTRACT

A computer based system for the collection, analysis and dissemination of data related to financial transactions using an Internet interface in order to minimize investment risk. The system includes a computer processor and a plurality of software applications adapted to run on said processor for performing a variety of functions. The processor and software together operate as a computer engine. A database is connected with the engine for storing data related to the transactions. Means are provided for inputting data to the database, and an application programing interface is carried by the engine for communication with software carried on third party systems through data feeds connected to the engine. A web application interface connected to the engine allows a user of the system to access the engine through a local terminal and display. The application interface permits the user to conduct searches of the database for information pertaining to a particular financial deal, said deal including a financial transaction or project and project profile. The software applications include at least one application programming interface for tracking deal analysis and storing the analysis on the database. The application interface permits a user to view the stored analysis on the user's local display.

### RELATED APPLICATIONS

The present application is a nonprovisional application based on, and claims priority to, provisional application 61/587,888 filed on Jan. 18, 2012, the contents of which are hereby incorporated by reference in its entirety.

### FIELD OF THE INVENTION

The present invention relates generally to the field of data collection, analysis and dissemination of or access to the collected data and/or the analyses of such data using Internet protocols and computer based systems for data storage and web interfaces for collection and dissemination or access. More specifically the invention relates to the unique aspects of collecting, analyzing, and disseminating data that is specific to the process of raising funds or of other financial transactions for a variety of projects, both profit motivated and non-profit. (A “financial transaction” or “project” may sometime herein be referred to as a “deal”.)

### BACKGROUND

Tracking and analyzing opportunities for raising funds or other company financial transactions can involve a multitude of diverse financial vehicles. Accordingly, to simplify an understanding of the invention, the description of the invention will be provided primarily in the context of one particular embodiment of the invention specifically useful for raising capital funds using social media and Internet connectivity. The confluence of social media, the Internet and recent relaxation of governmental regulations related to the general solicitation for the sale of a company's securities, has led to an expansion of fund raising through crowdfunding.

Accordingly, by way of example, the present invention will be described by reference to an embodiment of the invention as it relates to crowdfunding. Crowdfunding (sometimes called crowd financing or crowd sourced capital) has been defined as the collective cooperation, attention and trust by people who network and pool their money and other resources, usually via the Internet, to support efforts initiated by other people or organizations. Crowdfunding occurs for a variety of purposes, from disaster relief to publishing books to artists seeking support from fans, to political campaigns, to funding a startup company or small business.

Crowdfunding itself is well known for helping to raise charitable donations. It is receiving renewed attention from both commercial and social entrepreneurs now that social media, online communities and micropayment technology make it straightforward for sourcing donations from a group of potentially interested supporters, or for raising financial capital for new business opportunities from potential investors, at very low cost.

Whether crowdfunding is directed at profit-oriented investment opportunities, charitable purposes or artistic efforts, it is, at its core, a pooling of resources at the grassroots level with a framework for rewards and for the purpose of initiating an investment.

An entrepreneur seeking to use crowdfunding (such as for seed financing) typically makes use of online communities to solicit pledges of small amounts of money from individuals who are mostly not professional financiers. A range of variations are possible.

For example, the solicitation could be to back an idea with no direct material return offered to those making a pledge. This is common in artistic patronage and the normal activities of charity fundraising. Sometimes a threshold pledge approach is used, in which all pledges are voided unless the threshold amount is reached before the deadline. Another approach invites a display of sponsorship in return for the cash pledged. The solicitation could be to offer a non-interest bearing loan (microfinance), or some kind of quasi-equity investment could be offered, although any such arrangement would need to avoid falling under any applicable financial regulations regarding making a public offering of securities.

Crowdfunding allows good ideas, which do not fit the pattern required for conventional financing, to attract cash through an approach to “the crowd.” If the effort with the crowd is successful, not only can the enterprise secure seed funding to begin its project, but it may also secure evidence of backing from potential customers and benefit from word of mouth promotion. However, the crowdfunding approach means disclosing the idea for which funding is sought in public when the idea is at a very early stage. This exposes the promoter of the idea to the risk of the idea being copied and developed ahead of them by better financed competitors.

Other concerns related to crowdfunding are the limitations imposed by securities laws, since soliciting investments from the general public is most often illegal unless the security for sale has been filed with an appropriate regulatory authority, such as the Securities and Exchange Commission in the U.S., or other similar agencies in other countries. According to Section 5 of the U.S. Securities Act of 1933, it is illegal to sell any security unless such a sale is accompanied or preceded by a prospectus that meets the requirements of the Securities Act.

While there may be disputes as to whether a particular activity constitutes a sale of a security, any crowdfunding arrangement in which people are asked to contribute money in exchange for a share of potential revenue or profits based on the work of others, or involve some kind of ownership in the work of others, or contemplate a financial incentive such as an interest-bearing loan, would likely be considered a security. As such, the solicitation of the investment would have to be registered with a regulatory agency, unless it qualifies for one of several exemptions (e.g. Regulation D of the Securities Act of 1933). However, the United States recently enacted the Jumpstart Our Business Startups Act (the “JOBS Act”). Under this legislation, the United States Congress has mandated the Securities and Exchange Commission to relax the requirements of the Securities Act of 1933 relating to general solicitation for the sale of a company's securities. This legislation allows for crowdfunding to finance small business, with certain safe guard limitations, that would allow for raising limited amounts of money using mass communication protocols, such as social media networks over the Internet, without the usual filing requirements or with modified filing requirements.

While crowdfunding can be seen in cooperatives (co-ops) around the world, the Internet provides new streamlined approaches to quickly imitating the co-op model for low-level and/or sudden needs (i.e. disaster relief, travel expenses, legal fees, startup businesses, etc.).

Crowdfunding, like crowd sourcing (which is the act of sourcing tasks to a group of people), is very much related to online communities and social networks. The crowd can already exist as a community but they can also suddenly form from disparate groups around the world who all happen to share an interest in funding a person, project, event, campaign, or business enterprise, or in any other type of transaction to which the invention is applicable. The Internet allows for information to flow around the world, increasing awareness. A network with common interests for funding a project, or for participating in another type of financial transaction, can assemble and disassemble at any time.

In the same way that social networking changed how we allocate time, crowdfunding will change how we allocate capital. Crowdfunding, generally speaking, is the merger of group funding and social networking. While group funding dates back millennia, the social networking aspects of crowdfunding are quite new, and are a major driving force behind this revolutionary form of financing.

Building on social networking, crowdfunding creates a vehicle for people to invest or pledge money to projects for which they have an interest, a passion, or some other kind of attachment. In doing so, it creates a marketplace opportunity for a diversity of players. Whether financing a new movie, a fashion line, a sailing adventure, a startup business, or the next Olympic athlete, crowdfunding is being applied everywhere.

Accordingly, a number of websites have recently emerged to put investors or patrons or backers or political contributors in contact with entrepreneurs, artists, campaign managers and other endeavors. Many of these sites concentrate on, or are exclusively devoted to one type of investment or fundraising purpose. One example of such a website and the systems employed is described in now abandoned U.S. patent application Ser. No. 11/634,702 (US2007/0100729 A1). A potential investor would scour these websites in order to locate projects of interest. Existing websites usually operate competitively or for disparate purposes. Therefore, the potential investor or contributor is required to put in substantial effort to find what he or she is looking for. The same dilemma holds true for a person or group considering the launch of a crowd funded endeavor. In addition, the various websites fail to provide statistical data or comparison data, possible investor or sponsor background information, possible third party comments on a proposed deal, or means of analysis by which the potential investor can gauge the risks associated with any particular project, or by which a potential crowd funded endeavor can assess the optimal structure, venue, and mechanism for its crowdfunding initiative. The use of a computer based system can bring these elements together and provide needed foundations for assessing risk.

### SUMMARY OF THE INVENTION

An object of the invention, therefore, is to provide a computer based system and method for collecting, analyzing and disseminating date related to capital raising and other public or private company transactions and of the type needed in order to assess such transaction and minimize risk.

Another specific object is to provide a computer based system and method employing data collection, analysis and dissemination of information useful for locating and assessing crowdfunding opportunities.

Yet another objective of the invention is to provide a computer based system and method by which deal sponsors and founders of a project to be funded, deal investors, professional service providers, regulatory agencies, and others, can have access to central data storage capabilities so that searching numerous websites is eliminated, while also having access to analytical information helpful to the process of crowdfunding, or other project related transactions. Such a system and method will not eliminate the need for individual project websites which are devoted to narrow fields of interest. Rather, it will supplement these websites by providing additional capabilities which are made possible through the aggregation and analysis of large amounts of data.

The present invention adds structure and transparency to crowdfunding and other company transactions by aggregating project financing data and social networking data which results from the process of crowdfunding projects, regardless of the type of projects or geography of projects or whether or not projects are successfully funded. The invention incorporates analytical software and application programing interfaces (“APIs”), which are routines and tools for building applications for third-party developers, and makes crowdfunding and tracking other types of company transactions more efficient for market participants with analytical software resulting from data collection combined with third-party software.

Thus, the raw data from a variety of public sources including the Internet, disclosure documents, press releases, and social networking platforms, is used as the foundation for the system and the building blocks for developing project profiles for analysis.

The software platform of the invention is based on the use of “project profiles.” When a person, company, group or any other entity (sometimes referred to herein as the “project sponsor” or “founder”) who wishes to seek funds for certain intended purposes, such as, for example, launching a new business venture, such project sponsor will submit details of the proposed project to a web site that will list the project for available financing. Such a website used for listing purposes is referred to herein as a “crowdfunding website” of a “listing website”. Once a project has been listed, it may also be referred to herein as a “defined project”. The details related to a defined project and which form the project profile herein include such things as the intended purposes of the defined project, a description of the proposed uses for the funds to be raised, details related to the individuals or other entities who are the project sponsors and founders, etc. The invention herein uses a project profile to be established in its system with the details related to each project. For every defined project there is a project profile in the system. The possible status of a defined project can be summarized as follows:
1) Active (defined project where the project sponsor is actively seeking financing).
2) Closed/Successful (defined project that is closed because the targeted financing was achieved).
3) Closed/Failed (defined project that is closed but the targeted financing was not achieved).
4) Pulled (defined project was posted on a crowdfunding website and then removed from that website).
5) Cancelled (defined project was cancelled by the project sponsor).
6) Unknown.

Editorial and other qualitative information that links the project profile to news of interest based on similarly funded projects or other areas of interest to a person viewing the project profile (such as news stories published on the Internet, financial research, or original editorial content produced by industry trade publications) is searched via an algorithm that hones in on what type of project was posted to a website identifying the project and compiles a list of stories that are based on projects, or other elements of projects, similar to that listed in the profile. The system of the invention also encompasses publication, over the Internet and through the system web interface, of news or editorial stories based on the analytical software employed by the system. These may be supplemented by independent research and include such items as information about the founders of the project, the project operating sector, the project idea, the project financials, the project business plan, etc. A community component that allows other people to compose write-ups on the defined project, blog and comment about the defined project, rank the popularity or viability of the defined project, post third-party research on the defined project, and include news postings related to the defined project is also part of the system. This type of information can generally be referred to as soft data as opposed to statistical facts, financial information and identification information which is often referred to as hard data.

The system of the invention also includes data storage for similar projects posted on, for example, listing websites and their associated data including things like type of project, amount of financing raised/sought, status of a defined project, venue or location of the intended activities related to the defined project, number of investors, and geography. Users of the system will be able to see a list of all the fees that the project sponsor paid, including fees paid to any listing website, and any other fees including finder fees, and professional fees.

Once the defined project has been successfully funded and the defined project is converted to full operations (referred to as the “funded company” or the “company”) in order to implement the intentions and purposes of the defined project, the system allows for posting of post-deal information such as company performance data after funding, links to the company's website, news about the company, who the company's legal counsel or accountant is, etc. A benefit of the invention is in tracking the entities involved with these deals such as the service providers. This allows numerous stake holders to follow the success/failure and activities of the defined project and the entities associated with the defined project. The system accordingly allows for blogging or social networking type commentary and reviews by third-parties related to experiences with the defined project.

The data storage of the system also includes in the project profile critical disclosure information, such as profiles of the founders, initiators, as well as identification of all the entities involved in the project, including non-backers such as lawyers, accountants, and whomever else is involved with the defined project at the time the crowdfunding financing was consummated.

When using the system of the invention in a crowdfunding embodiment, a user (i.e., anyone who has access to the system) will search for categories of interest and various criteria that will narrow search results. Therefore, the system separates projects based on a variety of criteria, such as projects that offer: (i) issuance of or sales of stock, (ii) nonprofit donations, (iii) interest bearing and non-interest bearing loans, (iv) advance product sales, (v) revenue sharing agreements, (vi) peer-to-peer lending, and so on. So, for example, if a prospective project sponsor is looking to start a restaurant in a particular locale which is to be funded through equity investment, that prospective project sponsor may access the system and search for all completed/successful similar restaurant projects within a 20 mile radius of the locale, for other successful equity-based projects. This type of search brings up a list of project profiles. Deeper analytics, such as viewing the number of investors, funders, initiators, backers, creditors, or other financial supporters that had participated in multiple restaurant projects, and even which backers tended to invest in those restaurant projects, is then available.

The system of the invention related to capital raising opportunities and other public or private company transactions includes a means for collecting data relevant to such transactions; a database for storing such data; an analytic engine electronically coupled to the database for analyzing the data, a web application in electronic communication with the analytics engine for interfacing with a variety of users, and a means for providing additional data directly into the analytic engine and API data feeds to other external systems.

More particularly, the system of the invention is a computer based system for the collection, analysis and dissemination of data related to financial transactions using an Internet interface and having a computer processor, a plurality of software applications adapted to run on said processor for performing a variety of functions related to the relevant data, said processor and said software together operating as a computer engine, a database connected with said engine for storing said data, means for inputting data to said database, application programing interfaces carried by said engine for communication with software carried on third party systems through data feeds, and a web application interface connected with said engine to allow a user of said system to access said engine through a user's local terminal and display, said data including listings of projects on listing websites, listings of potential investors categorized by specific criteria, such as type or location of projects of interest, third party analysis of particular projects, complete project profiles, which in addition to sponsors or founders and existing investors, includes details of the business objectives of the project, planned use of proceeds, amount of financing sought, backgrounds of project sponsors, said application interface permitting said user to conduct searches of said database for information pertaining to a particular financial transaction or project, said software applications including at least one application programming interface for tracking analysis of said financial transaction or project and for storing said analysis on said database, and said application interface permitting a user to view the stored analysis to thereby minimize risk.

The method of the invention involves the use of a computer based system for the collection, analysis and dissemination of data related to deals using an Internet interface from a user local terminal and display and includes logging onto the system by entering a user identification name and user passcode at said Interface, accessing a computer processor having a plurality of software applications adapted to run on said processor for performing a variety of functions, said processor and said software together operating as a computer engine, searching a database connected with said engine for storing said data including project profiles which may be input to said database, accessing an application programing interface carried by said engine for communication with software carried on third party systems, said application interface permitting said user to conduct searches of said database for information pertaining to a particular deal and project profile, said software applications including at least one application programming interface for tracking deal analysis and for storing said analysis on said database, and said application interface permitting a user to view the stored analysis.

In the crowdfunding embodiment, an analytics engine, which incorporates a computer processor and application software, housed on a server is where the primary analytical applications of the system run. Applications use data that is entered into a database or input into the analytics engine through Application Programing Interfaces (APIs). Some of the analytical applications of the system include: economic trends based on crowdfunding statistics; matchmaking services for putting project sponsors and investors together; issuer services that permit a prospective project sponsor to comply with regulatory requirements; trust tools which is an application program for analyzing social networking connections and contacts to provide information about project sponsors and/or investors; status designation applications for indicating a particular Investor's or project sponsor's interests or investment activities; valuation programs allowing the calculation of valuation metrics for a particular project; and software to allow third party computer systems to communicate with the system of the invention through data feeds.

Having described the invention in general terms, the invention will now be described by way of example in connection with a specific embodiment related to crowdfunding in conjunction with the annexed drawings.

### BRIEF DESCRIPTION OF THE DRAWINGS

In the following description, reference will be made to the annexed drawings, in the form of block diagrams, which provide illustrations of the system and the methods of the invention, and which include the following:

FIG. 1 is a system diagram that illustrates an overview of the system of the invention for a particular embodiment;

FIG. 2 is a diagram which illustrates relationships that outline how the database elements interrelate to each other through the database of the system;

FIG. 3 is an overview of the functionality available to a prospective project sponsor through the web application interface of the system;

FIG. 4 illustrates the process used by a prospective project sponsor to create a project profile on the system;

FIG. 5 illustrates the process used by a prospective project sponsor to browse all project profiles on the system;

FIG. 6 shows the process used by a prospective project sponsor to search for potential investors for crowdfunding on the system;

FIG. 7 is a block diagram that depicts the process used by a prospective project sponsor to search professional service providers on the system;

FIG. 8 is a block diagram that depicts the process used by a prospective project sponsor to search for another type of user on the system;

FIG. 9 illustrates the process used by a prospective project sponsor to analyze data and statistics on the system;

FIG. 10 illustrates the process used by a project sponsor to manage a network of friends on the system;

FIG. 11 is a block diagram that shows the process used by a project sponsor to manage their account on the system;

FIG. 12 shows the process used by a project sponsor to set up and manage alerts on the system;

FIG. 13 is an overview of the functionality available to a prospective investor through the web application/Interface of the system;

FIG. 14 shows the process used by a prospective investor to browse defined projects for possible investment in a defined project; and

FIG. 15 shows the process used by a prospective investor to search for other potential investors on the system.

### DESCRIPTION OF THE INVENTION

An embodiment of the invention, useful for crowdfunding, will now be described.

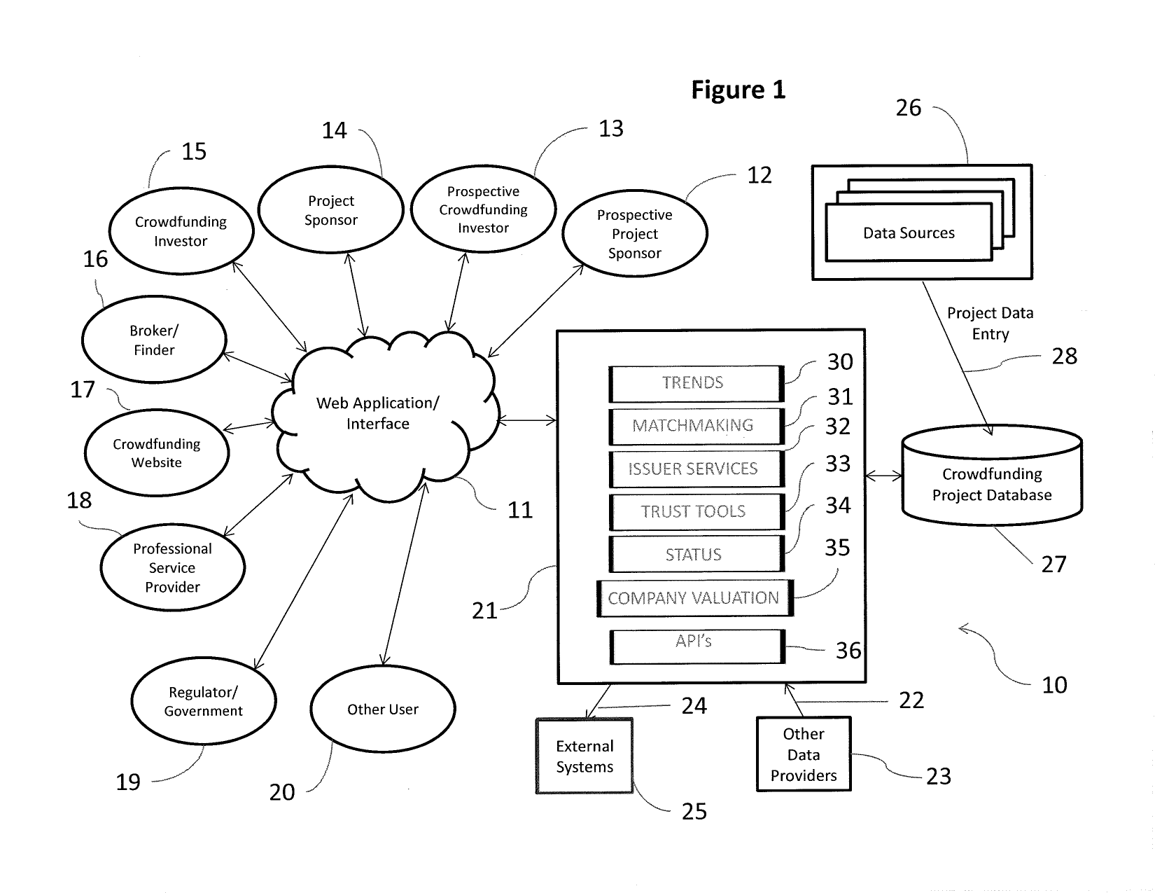

Referring to FIG. 1, a system 10 in accordance with the invention is illustrated. The system 10 includes a web application and interface 11. A variety of users will have access, through the Internet and by use of their local terminal and display screen (not shown in the drawings), to the system 10 through the web application and interface 11. Such users may include the following:

A prospective project sponsor 12 may use the system by access through the web application and interface 11. Such a prospective project sponsor may use the system to conduct data research and analysis to determine the optimal crowdfunding or listing website(s) to post a particular project as a fundraising opportunity in order to raise equity-based or debt-based financing, perform advanced-sales of products, receive a non-interest bearing loan, receive charitable contributions or donations, or receive other consideration; to search for investors, or other professional service providers.

A prospective investor 13 may use the system to search for a project as an investor, funder, backer, creditor, or other financial supporter of a project based on certain analytics.

A project sponsor 14 may access the system through the web interface 11 as an active sponsor of a project seeking crowdfunding in order to update and manage the process of fund raising.

A crowdfunding investor 15 may access the system as an active investor in a project(s).

A broker/finder 16 may use the system to perform analytics relating to the fees associated with defined projects, potential investors for defined projects, the crowdfunding structure, techniques of consummating investments in defined projects, and other data associated with defined projects and the entities associated with defined projects.

A crowdfunding website or listing website 17 can also access and use the system to conduct analytics to measure performance against competing crowdfunding websites and to perform analytics involving the entities associated with defined projects.

A professional service provider 18, such as a lawyer, accountant, business consultant, technology vendor, manufacturer, product designer, human resource recruiter, or any number of other providers, can use the system to search for data and perform analytics on defined projects and the entities involved in defined projects; use the system to network and connect with other users to promote business interests.

A regulator or government agency 19 may also use the system to perform analytics that provide transparency of defined projects using defined project data, investor data, broker/finder data, professional service provider data, and other user data, to analyze and investigate unauthorized crowdfunding techniques, illegal activities, and instances of fraud perpetrated by users of the system on investors and/or others; use the system to provide a means for reporting and disclosure and other purposes as mandated by regulatory agencies.

Other users 20 can include a large number of possible interested parties to perform industry analysis, search for content ideas, find sources and for other academic or research purposes. Such other users may include independent researchers, academics, bloggers, journalists and other media parties.

Sources of data 26 include multiple sources of data, including but not limited to the Internet, defined project disclosure statements, press releases, government or regulatory disclosures, social networking websites, and other independent research which produces data. Such data includes listings of projects on various listing websites, listings of potential investors categorized by various criteria, such as type or location of projects of interest, third party analysis of particular projects, complete project profiles, which in addition to sponsors or founders and existing investors, will include details of the business objectives of the project, planned use of proceeds, location to be conducted, broker/dealers involved, amount of financing sought, amounts of financing already obtained, backgrounds of the project sponsors, founders and existing investors, and other similar pertinent information relating to a particular project.

The data culled from the sources 26 is entered into a database 27 through a well-known process of project data entry 28 by which researchers or the system software collects and enters the data into the database 27.

Deals will be stored in the database 27 using the following categories or criteria for storage information:

a Deal Name
i The name of the deal.

b Deal Amount
i The amount of capital related to the deal and proposed use of proceeds.

c Deal Date
i This is the date the deal is open as of.

d Created On
i The date the deal was created.

e Created At
The time the deal was created.

f Created By
i The person, people, company, companies, document, documents, deal or deals that created the deal.

g Deleted
i This denotes whether the record has been deleted.
ii This is one of three values;
   1 Null—The record exists, but the deleted field has not been touched yet.
   2 True—The record is deleted.
   3 False—The record is not deleted.

h Visible
i This denotes whether the record is visible in the system or is hidden.
ii This is one of three values;
   1 Null—The record exists, but the visible field has not been touched yet.
   2 True—The record is visible.
   3 False—The record is not visible.

i Claimed
i This denotes whether a company or person has claimed ownership of the deal.
ii This is one of three values;
   1 Null—The record exists, but the claimed field has not been touched yet.
   2 True—The record is claimed.
   3 False—The record is not claimed.

j Owner(s)
i The owner(s) of the deal.
ii The person, people, company, companies, document, documents, deal or deals that owns the deal.

k Active
i This denotes whether this is an active deal..
ii This is one of three values;
   1 Null—The record exists, but the active field has not been touched yet.
   2 True—The record is active.
   3 False—The record is inactive.

Company information will be stored in the database 27 using the following minimum categories or criteria:

a Company Name
i The name of the company.

b Created On
i The date the company was created.

c Created At
i The time the company was created.

d Created By
i The person, people, company, companies, document, documents, deal or deals that created the company.

e Deleted
i This denotes whether the record has been deleted.
ii This is one of three values;
   1 Null—The record exists, but the deleted field has not been touched yet.
   2 True—The record is deleted.
   3 False—The record is not deleted.

f Visible
i This denotes whether the record is visible in the system or is hidden.
ii This is one of three values;
   1 Null—The record exists, but the visible field has not been touched yet.
   2 True—The record is visible.
   3 False—The record is not visible.

g Claimed
i This denotes whether a company or person has claimed ownership of the company.
ii This is one of three values;
   1 Null—The record exists, but the claimed field has not been touched yet.
   2 True—The record is claimed.
   3 False—The record is not claimed.

h Owner(s)
i The owner(s) of the deal information.
ii The person, people, company, companies, document, documents, deal or deals that owns the company.

i Accredited
i This denotes whether this is an accredited investor.
ii This is one of three values;
   1 Null—The record exists, but the accredited field has not been touched yet.
   2 True—The record is accredited..
   3 False—The record is non-accredited.

People information (such as individual sponsors, investors, professional providers, etc.) will be stored in the database 27 using at least the following categories or criteria:

a Person Name
i The name of the person.

b Created On
i The date the person was created.

c Created At
i The time the person was created.

d Created By
i The person, people, company, companies, document, documents, deal or deals that created the person.

e Deleted
i This denotes whether the record has been deleted.
ii This is one of three values;
   1 Null—The record exists, but the deleted field has not been touched yet.
   2 True—The record is deleted.
   3 False—The record is not deleted.

f Visible
i This denotes whether the record is visible in the system or is hidden.
ii This is one of three values;
   1 Null—The record exists, but the visible field has not been touched yet.
   2 True—The record is visible.
   3 False—The record is not visible.

g Claimed
i This denotes whether a company or person has claimed ownership of the person.
ii This is one of three values;
   1 Null—The record exists, but the claimed field has not been touched yet.
   2 True—The record is claimed.
   3 False—The record is not claimed.

h Owner(s)
i The owner(s) of the deal information.
ii The person, people, company, companies, document, documents, deal or deals that owns the person.

i Accredited
i This denotes whether this is an accredited investor.
ii This is one of three values;
   1 Null—The record exists, but the accredited field has not been touched yet.
   2 True—The record is accredited.
   3 False—The record is non-accredited.

Documents information will be stored in the database 27 using at a minimum the following categories or criteria:

a Document Name
i The name of the document.

b Created On
i The date the document was created.

c Created At
i The time the document was created.

d Created By
i The person, people, company, companies, document, documents, deal or deals that created the document.

e Deleted
i This denotes whether the record has been deleted.
ii This is one of three values;
   1 Null—The record exists, but the deleted field has not been touched yet.
   2 True—The record is deleted.
   3 False—The record is not deleted.

f Visible
i This denotes whether the record is visible in the system or is hidden.
ii This is one of three values;
   1 Null—The record exists, but the visible field has not been touched yet.
   2 True—The record is visible.
   3 False—The record is not visible.

g Claimed
i This denotes whether a company or person has claimed ownership of the document.
ii This is one of three values;
   1 Null—The record exists, but the claimed field has not been touched yet.
   2 True—The record is claimed.
   3 False—The record is not claimed.

h Owner(s)
i The owner(s) of the document.
ii The person, people, company, companies, document, documents, deal or deals that owns the document.

People and companies can also be stored in the database 27 using a criteria as to whether or not they are a) an accredited investor, or b) a non-accredited investor.

A deal can be stored to indicate whether it is a) active, or b) inactive.

Under the Securities Act of 1933, a company that offers or sells its securities must register the securities with the SEC or find an exemption from the registration requirements. If they are offering or selling, then the deal is categorized as active. If they are not offering or selling, then the deal is inactive. The Act provides companies with a number of exemptions. For some of the exemptions, such as under rules 505 and 506 of Regulation D, a company may sell its securities to what are known as “accredited investors.” The federal securities laws define the requirements for accredited investors.

The step to display an accredited person or company is based on checking the Accredited field for the person or company. If the person or company is accredited, the person or company is displayed as an accredited investor in the system.

The step to display an active deal is based on checking the Active field for the deal. If the deal is active the deal is displayed as an active deal in the system.

The software used to analyze the collected data is housed and operated on a server processor forming an analytics engine 21. The analytics engine 21 is also connected to the web-based application that serves as the interface 11 to the users.

Various software applications are housed in the analytics engine 26.

One such application is referred to as a trend applications 30, which is a software program for conducting analysis based on macro industry statistics on crowdfunding, sector and geographical statistics on crowdfunding and information that would be of interest on a broad topic level such as league tables on active investors, crowdfunding websites with the most successfully completed fundraisings in a certain sector, etc. The trends application also includes algorithms for analyzing traffic and other statistics pertaining to crowdfunding websites such as rankings of such websites based on whether traffic to those websites is global or local search traffic in order for users to determine which crowdfunding websites were prevalent in various geographies or parts of the Internet.

Matchmaking application 31 is a software program having an algorithm that provides what might be considered a match-making service for investors and project sponsors, for professional service providers, and for other users of the system. Similar to the way online dating websites rely on algorithms to add specificity in order to connect people looking for dates, because of the high volume of projects on crowdfunding websites, the system, using the data stored in the database 27 according to the criteria by which it is listed, as described above, provides automated tools to match investors with defined projects and project sponsors. Similarly a variety of system users can be matched with other users of the system. The system assigns such combinations a “match score.” For investors, the application includes everything from basic screening capabilities to email alerts letting an investor know when a defined project they are following has been successfully funded or when a new project that meets their interest criteria has been posted on a crowdfunding website. For project sponsors, the matchmaking application includes searching for the most active and/or relevant prospective investors to determining the optimal crowdfunding website to post a project on, or offering multiple crowdfunding websites whereby an intended project can be fractionalized such that portions of the fundraising occurs on several crowdfunding websites. For example, this might be the case for a proposed project that seeks exposure to a particular audience focused on a specialized sector and another audience focused on a specialized geography.

Using the example of an equity-based fundraising for a restaurant project, the prospective project sponsor might choose to seek a portion of its fundraising through a listing website which specializes in restaurant-type businesses and another portion of its fundraising on a different listing website which specializes in businesses located within the geographical region in which the prospective project sponsor is aiming to establish its operations, thus fractionalizing the crowdfunding initiative between two different crowdfunding listing website venues. The system provides for both the analysis of the ideal fractionalization of the fundraising and the mechanism, through APIs, whereby the prospective project sponsor is able to post its project (thus becoming a defined project) on multiple crowdfunding websites. In this scenario, the system serves as a “meta-site” coordinating the defined project postings amongst various website venues.

Other matchmaking applications including those for professional service providers to connect project sponsors with human resource recruiters, lawyers, accountants, graphics designers, PR firms, outsourcing firms, and the like, is also an application of the system. A related component of the system includes a project score whereby individual data points may be entered by the prospective project sponsor or another user associated with a project and include such things as identifying the addressable market size for the defined project's target market, the region of the defined project's operation, the number of employees required for the defined project, and so forth. These data points are then used by an algorithm to determine a score for a prospective investor to easily search for a project and to determine the compatibility between a selection of projects and that particular Investor's interest criteria.

An issuer services application 32 allows a prospective project sponsor to incorporate itself using an application designed for “issuer services” that provides for various functionalities enabling the project sponsor to comply with crowdfunding laws and regulations. By way of example, since June of 2008, the state of Vermont is allowing companies to form and operate entirely online. Presently, there is no need for paper based filings, in person annual meetings, or a physical address for the company. Some believe this might position Vermont to be the “Delaware of the Internet.” For prospective project sponsors in need of incorporation prior to posting a project, services such as virtual incorporation or online incorporation will be available using this application of the system. The application will allow prospective project sponsors the ability to incorporate their company through the system and entirely online This application, for example, may be offered in conjunction with the state of Vermont through an API.

Another issuer service offered through the system is a virtual transfer agent application whereby a project that subsequently becomes a company issuing shares to its investors, is able to manage the share issuance, and manage the shareholder ledger associated any subsequent trading in shares between the company's investors. Because of the data collected in the System that relates to the crowdfunding investment, this virtual shareholder management service is able to track share issuance and trading in electronic book form.

The system provides a trust tools application 33 also housed in the analytics engine 26 that analyzes the social networking that connects a defined project and project sponsors with its investors, with professional service providers and with other users. For example, trust tools determine how close a particular investor is to a defined project with a goal of perhaps determining who is family and friends, who is connected to the defined project's family and friends, and who is part of a viral marketing group of investors without any discernible connection to the defined project. By way of example, different levels of friend might be defined as follows:

1^{st} Level Friend—defined project founders or project sponsors.

2^{nd} Level Friend—defined project friends and family.

3^{rd} Level Friend—friends of defined project friends and family.

4^{th} Level Friend—no discernible connection to a defined project.

At the founder or project sponsor level, the trust tools application provides additional disclosure about what kind of interest founders had/have in their own defined project. The trust tools programs are a part of the application that helps a user determine how legitimate or qualified a defined project funding is. For example, if there is too much funding coming from founders or project sponsors, or if there is too much funding from friends and family, and there's no social-networking component to the funding, that might be considered a warning indicator. In another way, an Investor would use the trust tools application to avoid any project that's getting funded too quickly, too slowly, or has another pattern of funding momentum that is considered suspicious. The trust tools application helps a user determine where the investors are in the social networking scheme of the defined project. Some investors may prefer to support a defined project with certain social profiles and that's why the trust tools application is able to leverage the data collected in the system and utilize graphical depictions to make analyzing the data easier.

Because crowdfunding is a social activity whereby people invest in projects which they have an emotional and social attachment to, the system uses a method designating a certain status relating to crowdfunding activities. The system therefore includes a status program 34 that employs the use of badges to designate such status These crowdfunding badges represent a particular investor's interests, and overall investment activity, in the system with the aim of providing investment proclivities so that investors with similar interests can connect with one another and project sponsors can target specific power-users who have interests that might be complementary to their defined project. Power-users with certain badges will also be considered the most credible people writing reviews on projects, writing reviews and commentary on project founders or project sponsors, and commenting on other trends through the social network applications of the system.

A company valuations application 35 is included to provide an application allowing for calculating a variety of valuation metrics on defined projects. For example, with respect to equity-based deals, valuation at the time of the crowdfunding is one such metric. The valuation application includes algorithms for determining company valuation using standard metrics. Through the system's application post-deal closing, if needed disclosure is available, the system can provide a follow-up component to valuation after the project has initially been funded. This typically occurs on a subsequent event, such as later-stage financing or M&A event.

Application programming interfaces 36, or crowdfunding related API's communicate with the system analytics engine 21 through data feeds 24 and data integrations with third-party software. Such communication and integration allow third party software systems to communicate with the system, thereby enhancing the applications of the system.

Specifically, a crowdfunding website API is a programming interface connecting the analytics engine 21 with third party listing websites for listing projects. This allows a project to be shared or fractionalized. A project sponsor might want to post a project on a specific listing website based on the analytics through the system or they might want to post “half” of the project on one website and half of the project on another website. The project sponsor might do this to diversify based on where the funds are coming from, or because one listing website specializes in a particular geographical region and another in a particular sector, and the project sponsor aims to target both areas. Through the listing website API, a project sponsor will be able to achieve this using the system. Other applications with this API are also possible. For example, the system provides for a mechanism for a “meta crowdfunding account” such that investors can manage all of their investments using one application on the system that connects all of their defined project investments on a variety of crowdfunding websites.

A research API allows third-party research analysts to connect to the system much like they would connect to data distribution outlets covering the public equity markets. This allows research groups to post their analysis directly onto the system platform through this API.

A professional services API allows third-parties, such as law firms, accounting firms, etc., to post template agreements for fundraising transactions. Since crowdfunding is a community-based funding method, promoting best practices and standards is important. This API has the effect of open sourcing (as that term is understood in the art) deal terms so that there is more disclosure, and more uniform disclosure, making the fundraising data easier to collect and dissect. In the same way, the system provides third-party interfaces for a variety of legal services including patent and intellectual property, employment and labor, etc. This professional services API promotes more disclosure of crowdfunding data via standardized documentation used within the context of professional service providers such as lawyers, accountants and other professional entities.

A fraud API connects the system to third-party applications, so that the system is able to assess the likelihood that a defined project might be a fraud. This is accomplished in a variety of ways including looking at and analyzing data related to geography, or the project sponsors, or connecting such sponsors to other failed endeavors.

Because of the economics received by crowdfunding websites, they are not likely to post such fraud-related data and information because ultimately, they want to encourage backing of projects due to the compensation structure of funding and how crowdfunding websites are paid fees, and more importantly, because crowdfunding websites do not have the aggregated data required to properly screen for fraud assuming a fraudster would pose as a legitimate project sponsor on multiple websites.

The fraud API helps investors and other users of the system to “connect the dots” and help identify instances of fraud and possible instances of fraud. Because of the community-based approach to crowdfunding, with available API data, the “crowd” will be in a position to identify the potential for fraud and can post comments or otherwise notify prospective project investors before they could be defrauded. The system incorporates an API so entities who specialize in fraud, such as fraud detection companies or background/credit checking companies, maintain data feeds into the system. Different kinds of fraud screens and fraud scores are incorporated into the application. These include measuring the speed at which a defined project gets funded to determine if there's a fraud to analyzing the crowdfunding investors in a defined project to determine if they are from known social networking sites or have some legitimate connection to the defined project.

The system includes a regulatory API to allow regulators and government agencies the ability to connect to the system. The system affords the transparency that regulators are interested in and promotes the use of best-practices and standards for crowdfunding data formats and reporting. Both inbound data integration through mandatory project sponsor disclosure and reporting requirements and outbound data feeds are incorporated into this regulatory API. An example of one application includes the reporting of basic information from potential project sponsors (e.g. name, address, and social security number of founders), which is entered into the system as part of the application process in order to post a project, and then integrated via the API to transmit the basic information to both the SEC and applicable state regulators for purposes of approving a defined project posting by regulatory agencies.

A user-lookup API provides detailed investor or other user information. The system can associate user names and other attributes of a defined project with identifiable information not provided on public crowdfunding websites. For example, assuming proper disclosure was provided, the system uses an authorization process to allow third-party data providers specializing in identification and background services to utilize the system's user lookup API to assist project sponsors in targeting specific investors, professional service providers, or other users. In much the same way a project sponsor could do a deeper background search on an investor, based on proper disclosure and authorizations, an investor is able to do a thorough background check on project founders, if desired.

External systems 25 include third-party applications, some of which are discussed above, that use the data or analytics offered by the system and integrates it with their own systems.

Other data providers 23, also connected with analytics engine 21 via a data feed 22, and which include third-party data sources, can be integrated into the system in order to directly provide data used by the system. Such third-party data providers may include capital markets, private companies, exchange rate data, fraud detection data and independent news or media sources.

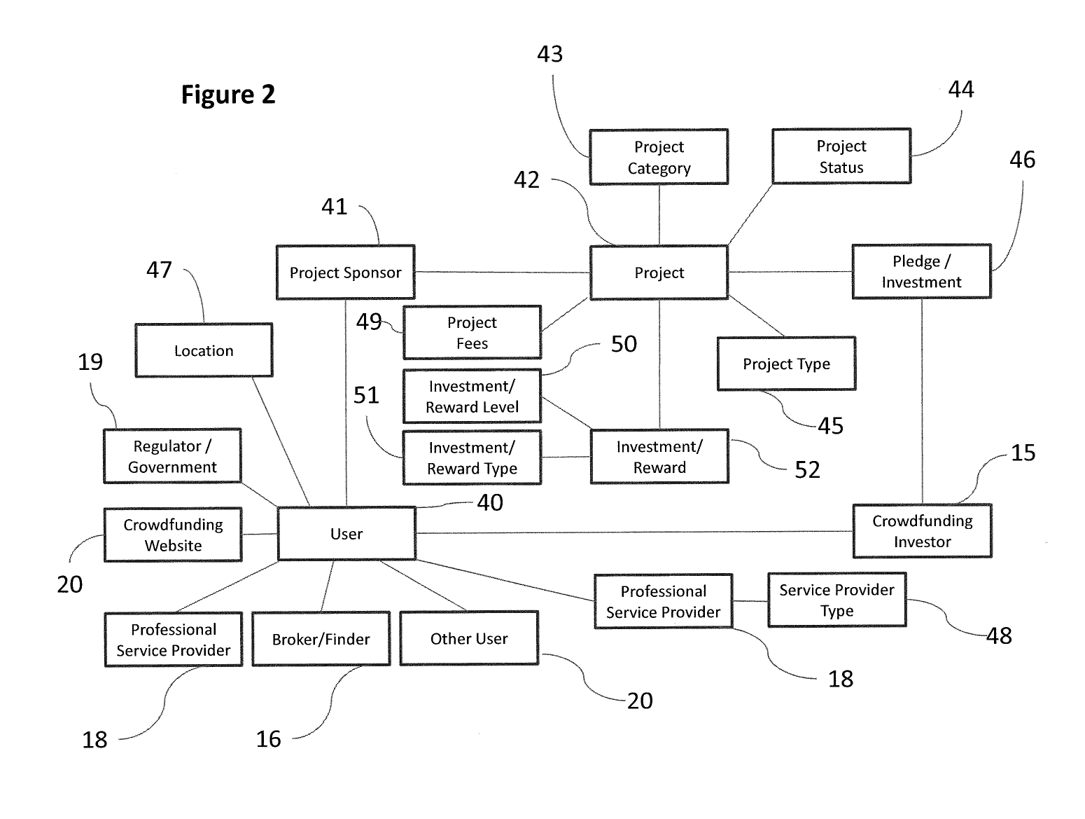

FIG. 2 is a block diagram illustrating how the various interested parties, i.e., the users, interact with the system for access to the data maintained on the system. So by way of example, a project sponsor 41, by accessing the system through the web application and interface 11, will be able to gain insight to the other users 40 including such users as regulators or government agencies 19, crowdfunding websites 17, professional service providers 18, brokers/finders 16, and other users of the system 20. In addition, these various users can connect with the system also through the web application and interface 11 for determining the venue or location 47 of a project. The ability to find this information is a result of storing the accumulated data using the storage criteria outlined above.

The project sponsor 41, once having accessed the system, may also connect with details of the project 42 which will include for example, project category 43, the project status 44, and the project type 45. The project sponsor 41, once having accessed the project will also be able to see any pledges or investments 46 made on that project. Investors 15 are also maintained on the system. Accordingly, through the various applications housed on the analytics engine 21, the project sponsor 41 may be able to locate investors 15, professional service providers 18, with an indication of the type of service provider 48 as well as the other users 40.

The data maintained in the system related to project fees 49, investments 50 and type of investments 31 are also accessible.

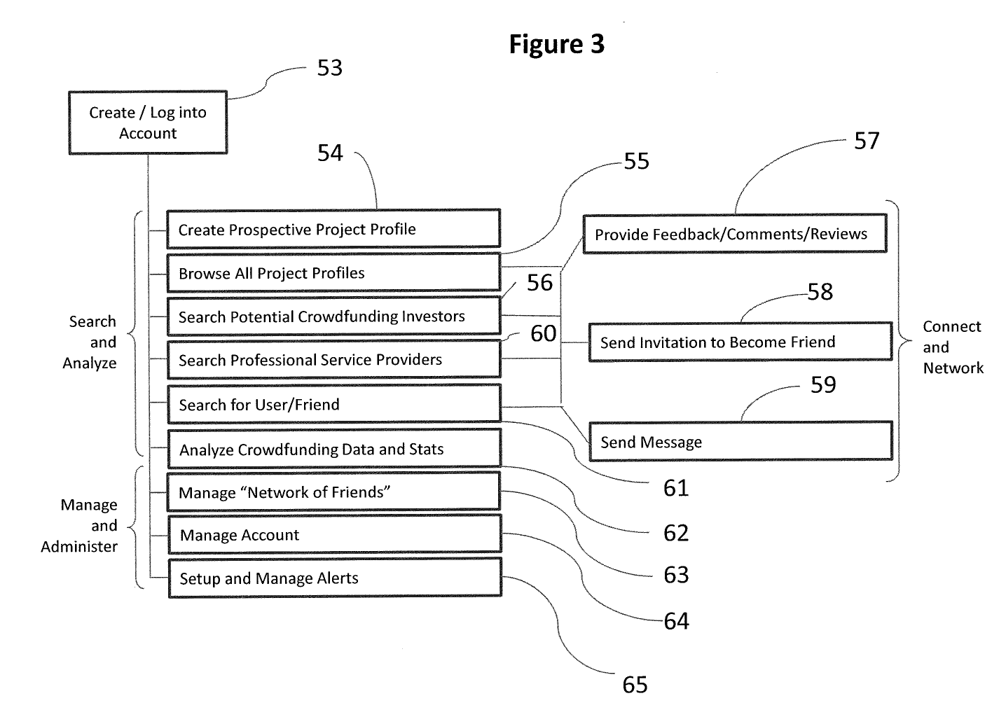

The method by which a prospective project sponsor will use the system with respect to a particular crowdfunding project is illustrated in FIG. 3. Here, a prospective project sponsor will log into the system and create an account using typical and well-known steps of creating a user passname or identification name and passcode. The prospective project sponsor will then create the project profile to be stored in the database of the system. The next step will be for the prospective project sponsor to browse all existing project profiles in the system so that he/she may be able to understand related existing projects or provide feedback to any other project sponsor.

The project sponsor will then use the applications in the analytic engine 21 in order to search for potential investors in his project. At step 60, the prospective project sponsor will also be able to search for professional service providers such as those discussed above in order to be able to access various services from law firms, regulatory agencies, broker/dealers, etc. Step 61 allows the prospective project sponsor to also search for other users and friends in the categories discussed above. At step 62, the prospective project sponsor 41 will, using the applications in the analytics engine 21 analyze the data and statistics relating to the project. Step 63 allows the prospective project sponsor to manage his network of friends in the various categories defined above, to manage his account at step 64 and to set up various alerts triggered by new information and data input into the system relating to the project.

Steps 54, 55, 56, 60, 61 and 62 are steps related to searching and analyzing. Steps 63-64 are steps that relate to managing and administering the prospective project sponsor's networks and accounts.

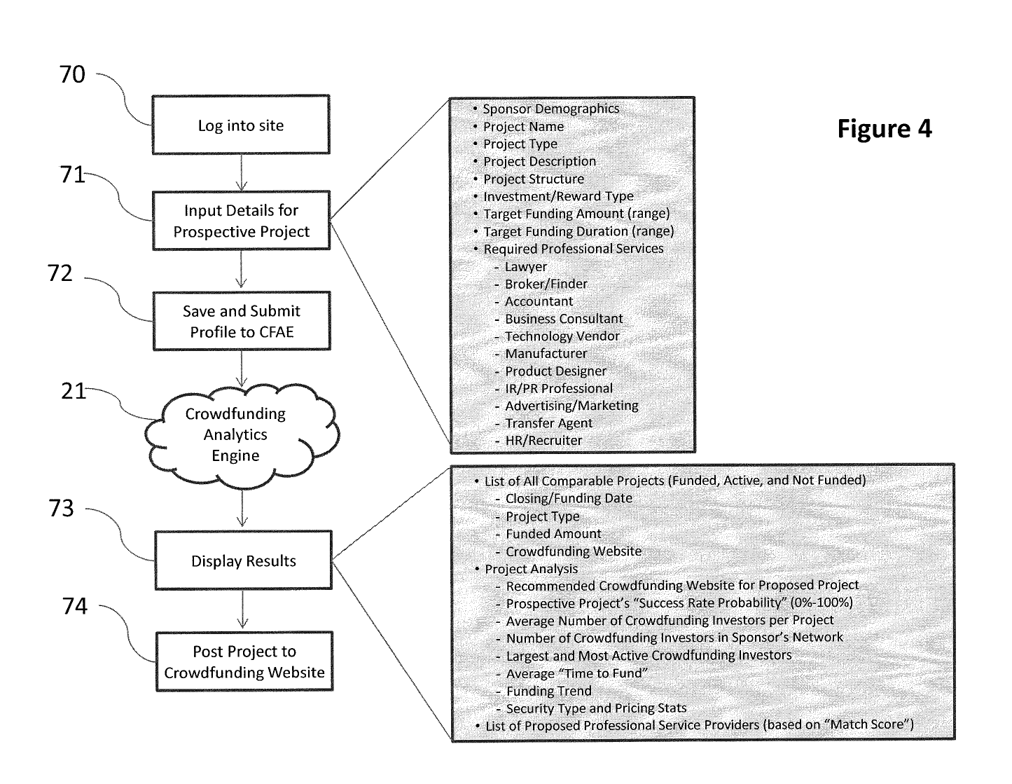

In order to create the prospective project profile, the prospective project sponsor will undertake the steps outlined in FIG. 4.

Here, the project sponsor logs onto the website housing the system at step 70, inputs the details of the prospective project at step 71 using the required input fields and criteria discussed above, saves and submits the profile to the analytics engine 21 at step 72 for storage in the database 27. Through the various applications and programs maintained on the analytics engine 21, the prospective project sponsor will then obtain the results he is seeking at step 73 on the display at the sponsor's local terminal. These include listings of comparable projects, whether funded, active or non-funded, and such details as the funding date, the type of project, the amount funded and any particular crowdfunding website which is hosting various comparable projects. In addition, the algorithms on the various applications contained in the analytics engine 21 will provide certain analysis. These included recommended crowdfunding websites for this sponsor's proposed project, a rating for the likely success of funding this project, an indication of the average number of crowdfunding investors per project in this category, the number of investors in the sponsor's network, the largest and most active investors, the analyzed prospective average time to fund this type of project, funding trends and pricing statistics. At this stage, the sponsor will also be able to understand from the systems a list of proposed professional service providers based on the various match scores the system uses.

At step 74, the project can then be distributed for posting to recommended or chosen crowdfunding or listing websites.

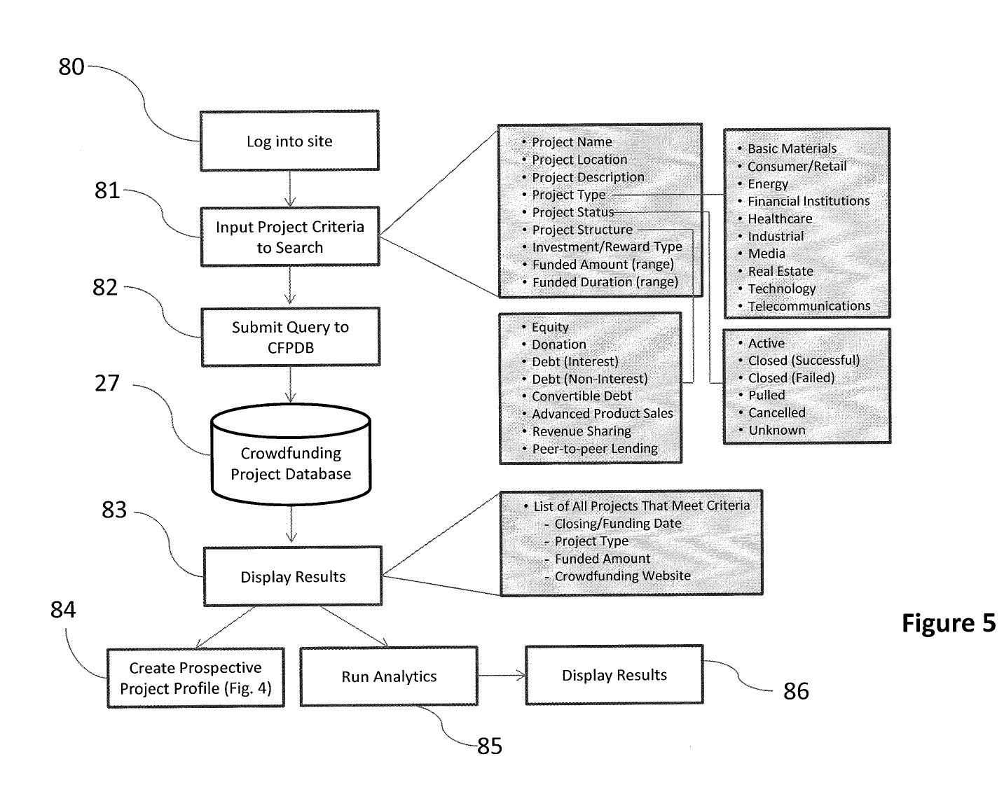

At FIG. 5, the method of browsing various project profiles is illustrated. Here, a project sponsor or any other user may log onto the site at step 80 and then at step 81 input project or deal criteria used to search for other project profiles. Such criteria will include a project name, a project location, a project description, a project type (including for example, projects related to basic materials, consumer or retail projects, energy related projections, financial related projects, healthcare, industrial projects, media related projects, real estate projects, technology projects, telecommunications related projects, etc.). The project criteria input at step 81 can also include the status of the project such as active, closed (successful), closed (failed), pulled, cancelled, or unknown. The project structure may also be described such as an equity transaction, a charitable donation project, a debt related project with interest, a debt related project without interest, convertible debt, advanced product sales project, revenue sharing or peer-to-peer lending projects. Other criteria can include type of reward expected with the investment, a range of the funded amount and a range for the funded duration.

At step 82, the query is submitted to the system database maintaining a database of projects.

The project database 27 then feeds results to the web application and interface 11 in order to display results at step 173. The displayed results include a list of all projects at 174. At 175, the investor may initiate the steps to complete an investment.

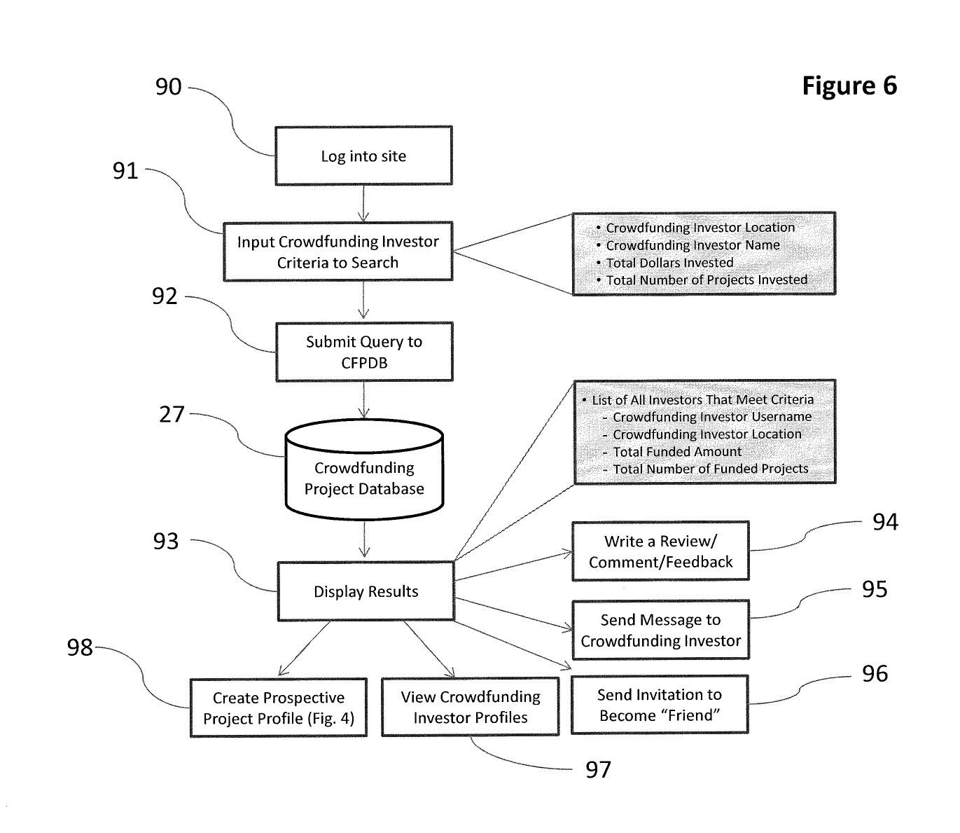

FIG. 6 illustrates the method of searching for other possible investors for a project. These steps include logging onto the site at step 90, and inputting investor criteria to be searched at step 91. This criteria includes known investor locations, investor names, amounts invested and total number of projects invested. Step 92 submits the query to the project database 27 and step 93 displays the results through the web application and interface 11. These results include a list of all investors that meet the criteria, investor names, investor locations, amount funded and number of funded projects. The user conducting the search can then write a review or comment and provide feedback to an investor at step 94, send a message to an investor at step 95, send an invitation at step 96 for the user to become a “friend” of the type described above, view investor profiles at step 97 and create a project profile at step 98.

In a similar fashion, FIG. 16 illustrates the steps of searching for professional service providers. Here, the user will log onto the website housing the system at step 100, input the criteria for the desired professional service at step 101. Such criteria may include the service provider's location, name, type of provider such as lawyer, broker/finder, accountant, etc. The query will be submitted to the database at step 102 and the results will be displayed at the web application and interface 11 at step 103. These results will include a list of all professional service providers meeting the criteria, including name, location, type and number of projects used. At this point, the user can again write a review or provide feedback at step 104, send a message to a service provider at step 105, send an invitation to the service provider to become a friend at step 106, view the professional service provider's profile at step 107 and at step 108 create a project profile.

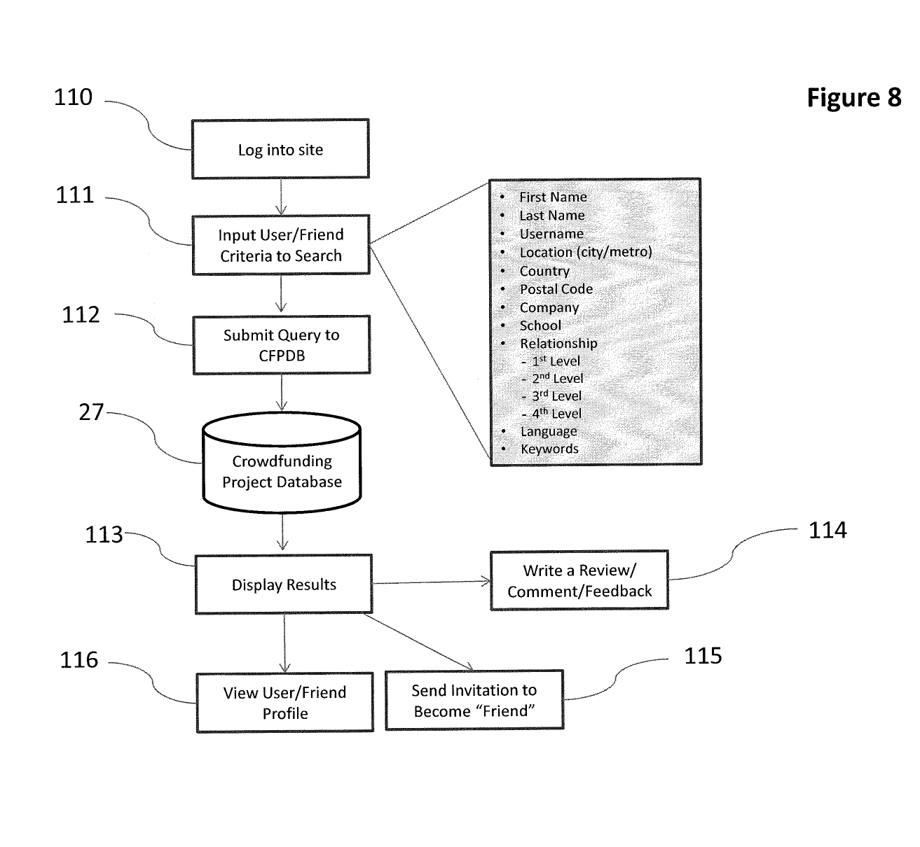

FIG. 8 illustrates the method of searching for a user/friend. Here, the user will log on at step 110 and input criteria at step 111. This input may include first and last name, a user name, a location including country postal code, etc., a company or school, and the level of friend relationship such as described above, and other key words. At step 112, the query will be submitted to the database 27 and at step 113, the results will be displayed through the web application and interface 11. At this point, the searcher may write a review or provide comment and feedback at step 114, send an invitation to become a friend at step 115 and view the user/friend profile at step 116.

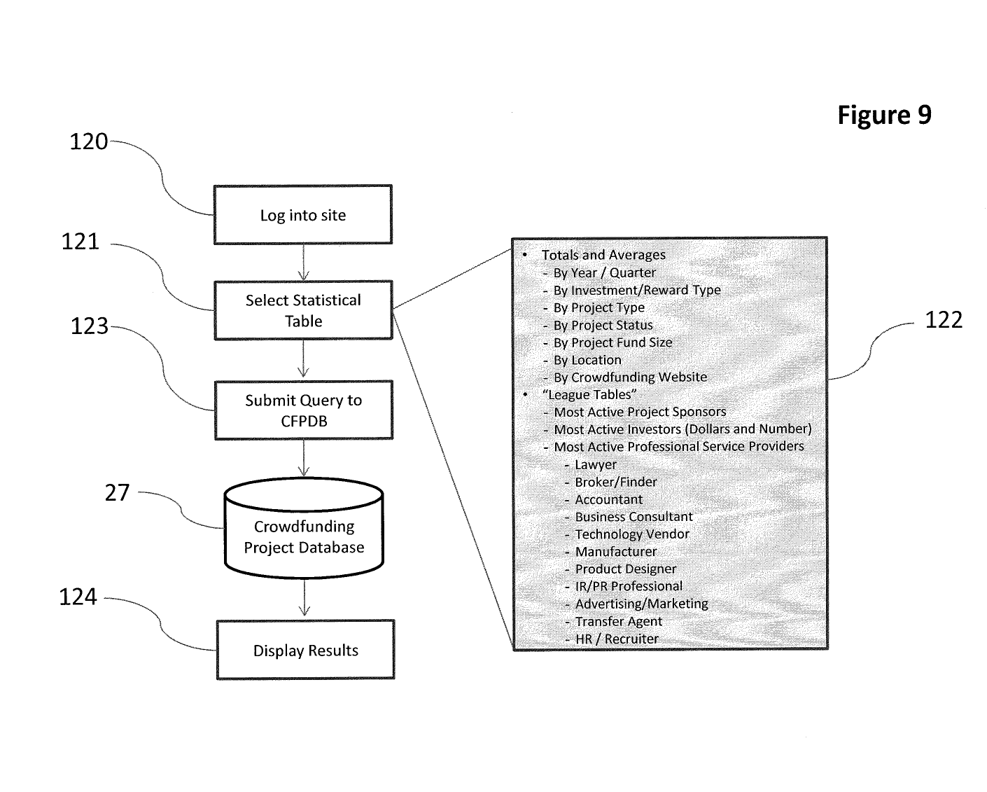

The method for analyzing data related to crowdfunding statistics is illustrated in FIG. 9. The user will logon to the website housing the system at step 120 and select a particular statistical table. The various statistical data grouped by table or categories is illustrated at step 122 in FIG. 9. These include specific statistics relating to project averages including by time period, project type, funding size, etc. There are also searching areas for the most active sponsors, investors and service providers. At step 123, the query is again submitted to the database 27 which after the search is conducted using the programs in the search engine and the data in the database, the results are displayed at step 124.

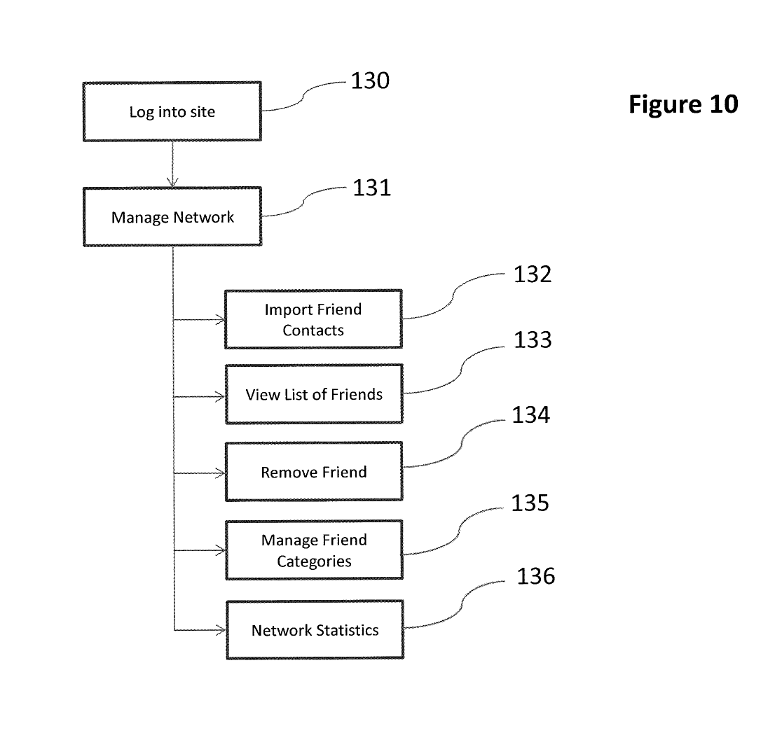

FIG. 10 illustrates the steps involved in managing a particular user's categories of “friends”. This again involves logging onto the system at step 130 and managing at step 131. This step includes importing the friends into a contact list at step 132, viewing the list at step 133, removing or adding friends at step 134, managing the friend category at step 135, and viewing network statistics at step 136.

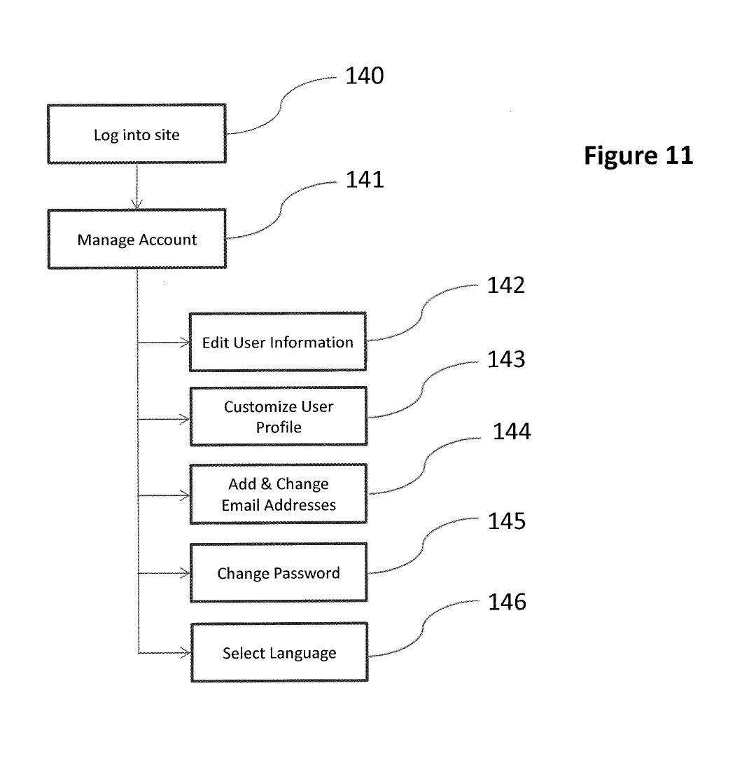

A user can manage his account on the system as illustrated in FIG. 11 by logging on at step 140, and managing the account at step 141. Managing the account includes editing any user information at step 142, customizing the user's profile at step 143, adding and/or changing email addresses at step 144, changing a password at 145, and selecting an appropriate language at 146.

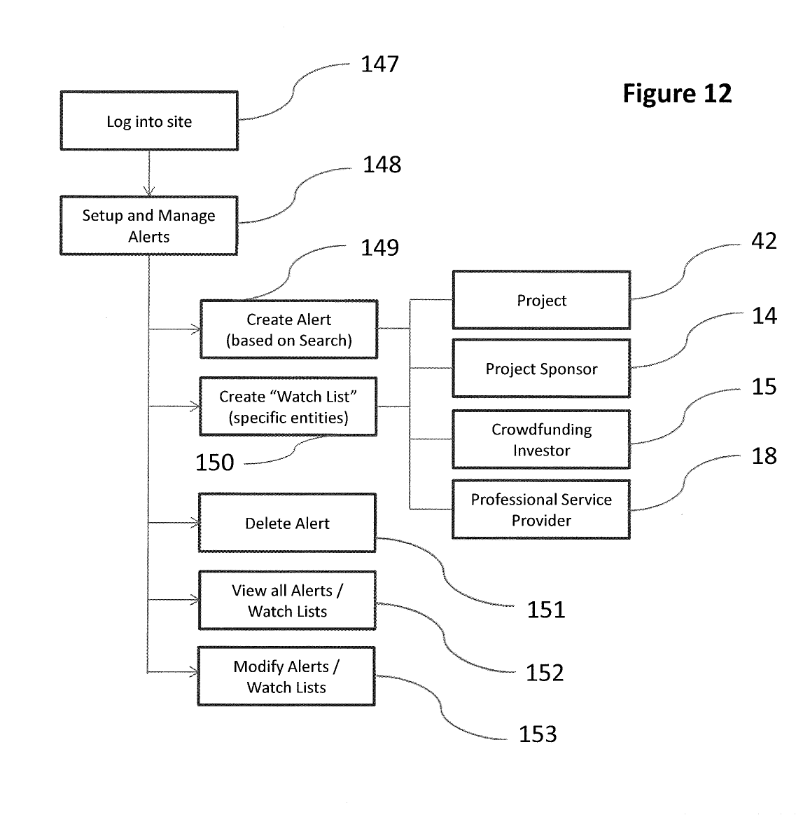

The system may also be used to establish and manage various alerts. This operation is described in connection with FIG. 12. Here, the user will logon at step 150 and move onto step 151 for setting up or managing alerts. An alert can be created at step 152 for being notified with regard to any activity relating to a particular project, a particular project sponsor, a particular investor, or a particular professional service provider.

At step 153, the user can establish a watch list for the same specific items of project, project sponsor, investor, or professional service provider.

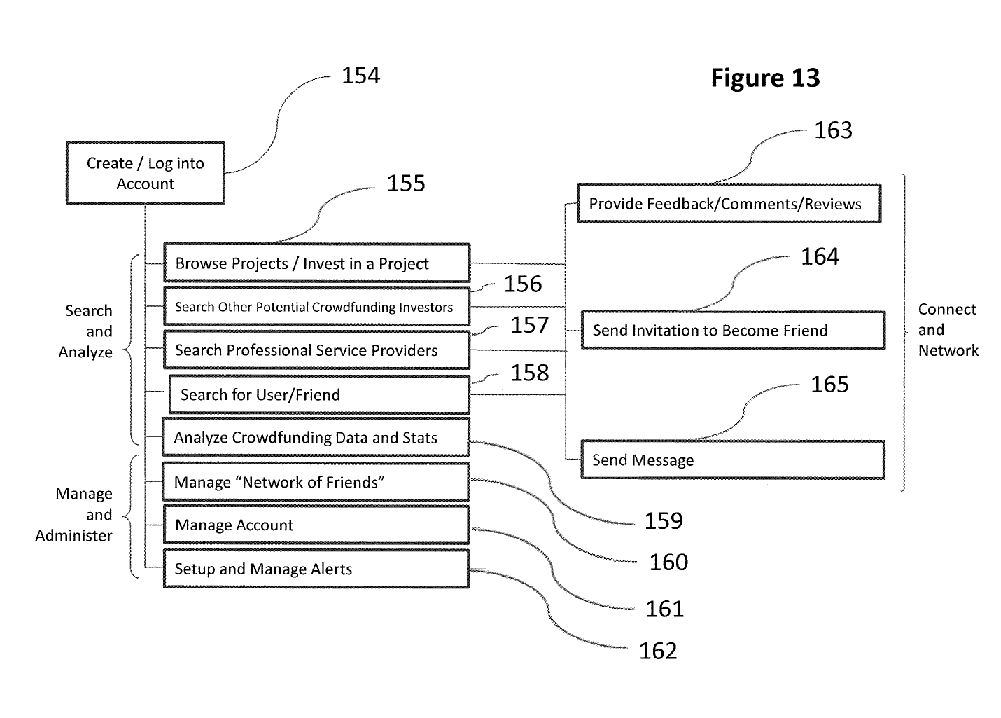

FIGS. 13-15 illustrate processes employed by prospective investors for using the system of the invention, similar to the processes employed by a prospective project sponsor discussed above.

The method by which a prospective investor will use the system with respect to a particular crowdfunding project is illustrated in FIG. 13. Here, a prospective investor will log into the system at step 154 and create an account using the same typical and well-known steps of creating a user passname or identification name and passcode. The investor browses the system for projects of interest at step 155. The prospective investor will then search for other potential investors at step 156. The next step will be for the prospective investors.

At step 157, the prospective investor will also be able to search for professional service providers such as those discussed above in order to be able to access various services from law firms, regulatory agencies, broker/dealers, etc. Step 158 allows the prospective investor to also search for other users and friends in the categories discussed above. At step 159, the prospective investor will, using the applications in the analytics engine 21 analyze the data and statistics relating to the project. Step 160 allows the prospective investor to manage his network of friends in the various categories defined above, to manage his account at step 161 and at 162 to set up various alerts triggered by new information and data input into the system relating to the project.

Steps 155, 156, 157, 158 and 159 are steps related to searching and analyzing. Steps 160-- 165 are steps that relate to managing and administering the investor's networks and accounts.

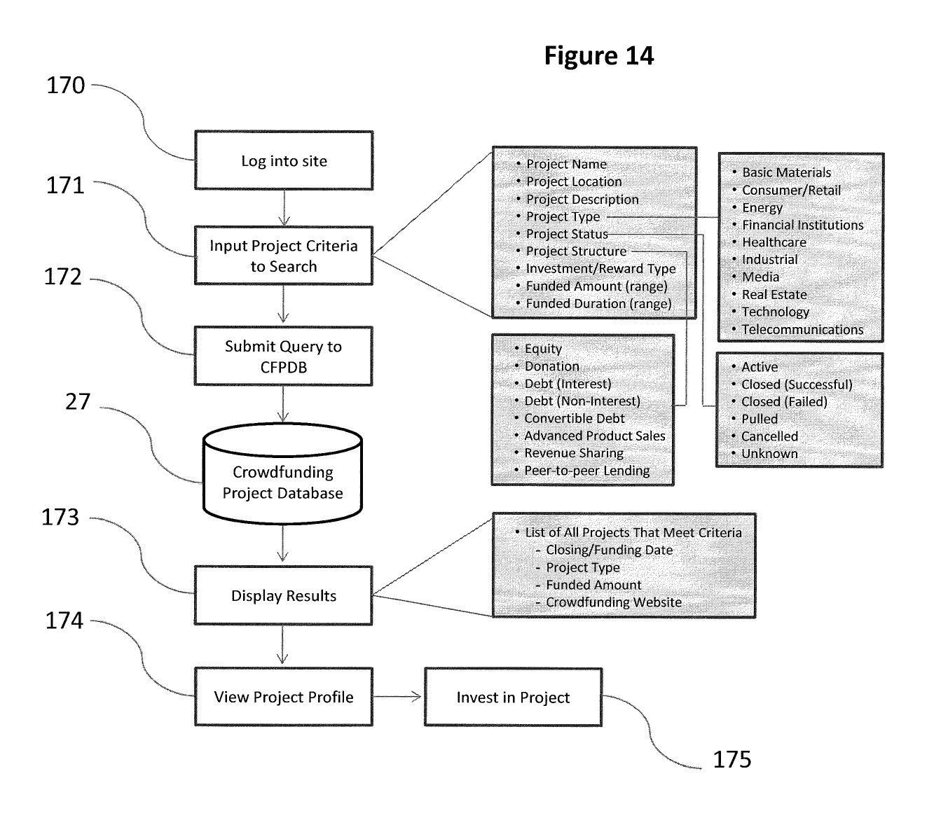

At FIG. 14, the method of browsing various project profiles is illustrated. Here, an investor may log onto the site at step 170 and then at step 171 input project criteria used to search for other project profiles. Such criteria will include a project name, a project location, a project description, a project type (including for example, projects related to basic materials, consumer or retail projects, energy related projections, financial related projects, healthcare, industrial projects, media related projects, real estate projects, technology projects, telecommunications related projects, etc.). The project criteria input at step 171 can also include the status of the project such as active, closed (successful), closed (failed), pulled, cancelled, or unknown. The project structure may also be described such as an equity transactions, a charitable donation project, a debt related project with interest, a debt related project without interest, convertible debt, advanced product sales project, revenue sharing or peer-to-peer lending projects. Other criteria can include type of reward expected with the investment, a range of the funded amount and a range for the funded duration.

At step 172, the query is submitted to the system database which maintains the database of projects.

The project database 27 then feeds results to the web application and interface 11 in order to display results at step 173. The displayed results include a list of all projects at 174 At 175 the investor may initiate the steps to complete an investment.

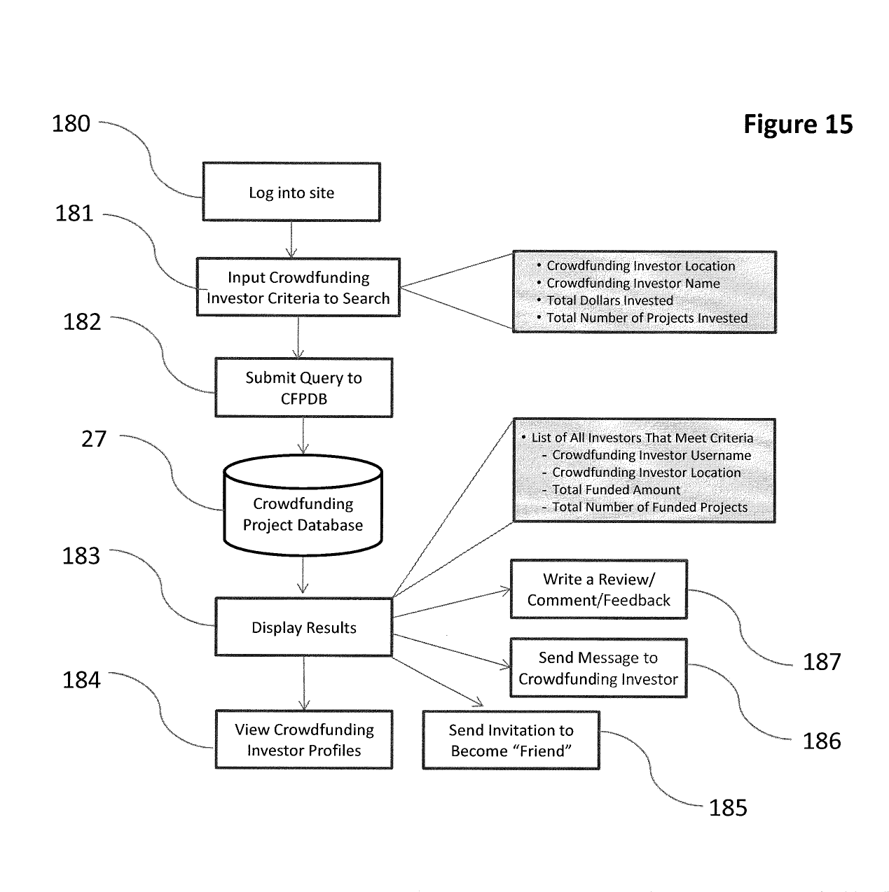

FIG. 15 illustrates the method of searching for other possible investors for a project. These steps include logging onto the site at step 180, inputting investor criteria to be searched at step 181. This criteria includes know investor locations, investor names, amounts invested and total number of projects invested. Step 182 submits the query to project database 27 and step 183 displays the results through the web application and interface 11. These results include a list of all investors that meet the criteria, investor names, investor locations, amount funded and number of funded projects. The user conducting the search can then write a review or comment and provide feedback to an investor at step 187, send a message to an investor at step 186, send an invitation at step 185 for the investor to become a “friend” of the type described above, view investor profiles at step 184.

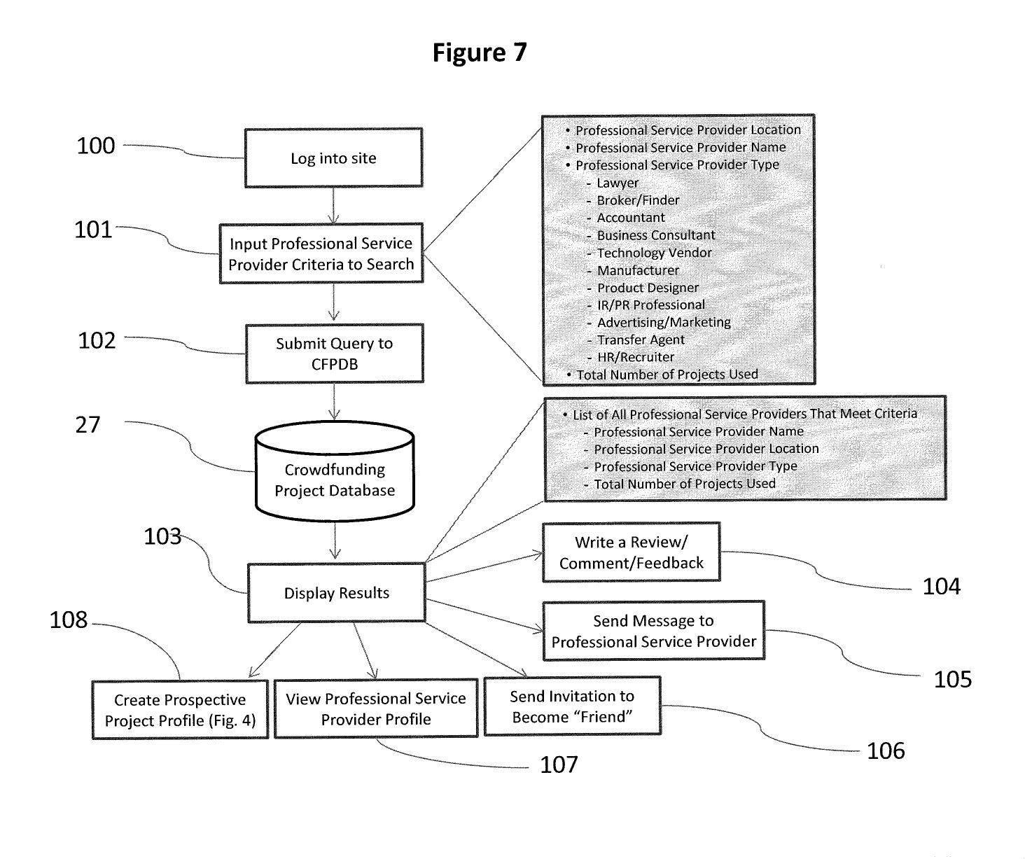

In a manner similar to the process for a project sponsor described in connection with FIG. 7, an investor may also search for professional service providers. Similarly, in investor may also search for a user/friend as described in connection with FIG. 8, or analyze data as described in connection with the process illustrated in FIG. 9.

An investor can also manage his account and alerts on the system in the same manner as illustrated described in connection with FIGS. 11 and 12.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A computer based system for the collection, analysis and dissemination of data related to financial transactions using an Internet interface, comprising a computer processor, a plurality of software applications adapted to run on said processor for performing a variety of functions, said processor and said software together operating as a computer engine, a database connected with said engine for storing data, means for inputting said data to said database using data storage criteria, application programing interfaces carried by said engine for communication with software carried on third party systems through data feeds, and a web application interface connected with said engine to allow a user of said system to access said engine through a user's local terminal and display, said data including listings of projects on listing websites by project criteria, listings of potential investors categorized by specific criteria, such as type or location of projects of interest, third party analysis of particular projects, complete project profiles, which includes details of the objectives of the project, planned use of proceeds, amount of financing sought, and backgrounds of project sponsors, said application interface permitting said user to conduct searches of said database for information pertaining to a particular financial transaction or project, said software applications including at least one application programming interface for tracking analysis of said financial transaction or project and for storing said analysis on said database, and said application interface permitting a user to view the stored analysis.

2. The computer based system according to claim 1 wherein said financial transaction or project is a crowdfunding transaction.

3. The computer based system according to claim 1 wherein said project and project profile is a crowdfunding project and project profile.

4. The computer based system according to claim 1 wherein said software applications includes an algorithm allowing a user to search the database by criteria for potential investors and/or sponsors.

5. The computer based system according to claim 1 wherein said software applications includes a program allowing a user to search third party listing websites for listed financial transactions or projects using specific deal criteria.

6. The computer based system according to claim 1 wherein said software applications includes a program allowing a sponsor of a project to connect through the system and to interact with third party professional service providers.

7. The computer based system according to claim 6 wherein said third party professional service providers include lawyers, accountants and corporate service providers.

8. The computer based system according to claim 1 wherein said project profile includes details of the project including purposes, a description of the project, a description of proposed uses of funds to be raised and identity of project sponsors and investors.

9. The computer based system according to claim 8 wherein said software applications include a program for conducting valuation calculations for a particular project based on said project profile and standard valuation metrics.

10. The computer based system according to claim 8 wherein said software applications includes an algorithm for searching news stories published on the Internet, financial research and editorial content related to project profiles similar to said project profile.

11. The computer based system according to claim 8 wherein said application interface allows a user to enter said system and access said data by logging onto said system by inputting a user identification name and passcode, and to upload for storage in the database a project profile.

12. The computer based system according to claim 1 further comprising computer software to permit a user to manage a network of friends in the system.

13. The computer based system according to claim 1 further comprising computer software allowing a project profile to be listed on third party listing websites.

14. The computer based system according to claim 1 further comprising computer software to permit conducting analysis based on macro industry and geographic statistics.

15. The computer based system according to claim 1 further comprising computer software to permit conducting analysis based on macro industry and geographic statistics.

16. The computer based system according to claim 15 wherein said software tracks Internet sites for post deal news stories and stores same in said database.

17. A method of using a computer based system for the collection, analysis and dissemination of data related to financial transactions or projects using an Internet interface from a user local terminal and display comprising entering a user identification name and user passcode at said Interface, accessing a computer processor having a plurality of software applications adapted to run on said processor for performing a variety of functions, said processor and said software together operating as a computer engine, searching a database connected with said engine for storing data including project profiles using specific search criteria, accessing an application programing interface carried by said engine for communication with software carried on third party systems, said application interface permitting said user to conduct searches of said database for information pertaining to a particular financial transaction or project and project profile, said software applications including at least one application programming interface for tracking financial transaction or project analysis and for storing said analysis on said database, and said application interface permitting a user to view the stored analysis.

18. The method according to claim 17 wherein said searches include searches for news stories, independent research and analysis, and editorial content.

19. The method according to claim 17 wherein said searches include searches for financial transactions or projects similar to such transaction project in which an investor contemplates and investment or in which a sponsor contemplates listing a project profile.

20. The method according to claim 17 wherein said searches include searches for potential investors and/or sponsors.

21. The method according to claim 17 wherein said searches include searches for third party listing websites for listed financial transactions or projects.

22. The method according to claim 17 wherein said project profile includes details of the project including purposes, a description of the project, a description of proposed uses of funds to be raised and identity of project sponsors and investors.

23. The method according to claim 22 wherein said software applications include a program for conducting valuation calculations for a particular project based on said project profile and standard valuation metrics.

24. The method according to claim 17 wherein said software applications includes an algorithm for searching news stories published on the Internet, financial research and editorial content related to project profiles similar to said project profile.

25. The method according to claim 17 further comprising the step of searching the system for information and data pertaining to performance after a project is funded.
